(19) United States
(12) Patent Application Publication
(10) Pub. No.: US 2016/0008783 A1
(43) Pub. Date: Jan. 14, 2016

(54) PHOTOCATALYTIC DEGRADATION OF SUGAR

(71) Applicant: EMPIRE TECHNOLOGY DEVELOPMENT LLC, Wilmington, DE (US)

(72) Inventor: David Max Roundhill, Seattle, WA (US)

(21) Appl. No.: 14/768,130

(22) PCT Filed: Dec. 18, 2013
(86) PCT No.: PCT/US13/76157

§ 371 Date: Aug. 14, 2015

Related U.S. Application Data
(60) Provisional application No. 61/765,607, filed on Feb. 15, 2013.

(51) Int. Cl. B01J 8/02; B01J 31/02; B01J 31/22; B01J 31/18; B01J 23/60; B01J 23/42; B01J 23/755; B01J 23/10; B01J 23/46; B01J 35/00; B01J 31/28

(52) U.S. Cl. CPC B01J 8/02; B01J 35/0006; B01J 31/0209; B01J 31/2295; B01J 31/1845; B01J 31/28; B01J 23/42; B01J 23/755; B01J 23/10; B01J 23/462; B01J 23/60; B01J 35/0013; B01J 35/004; B01J 2231/763; B01J 2531/821

(57) ABSTRACT

Systems having at least one photonic antenna molecule and at least one catalyst for degrading a sugar to degradation products using light energy are disclosed. Also disclosed are the devices and methods that use the systems for photocatalytically degrading a sugar into degradation products.

### CROSS-REFERENCE TO RELATED APPLICATION

The present application claims priority to U.S. Provisional Application No. 61/765,607, filed on Feb. 15, 2013, the entire contents of which are herein incorporated by reference.

### FIELD

The present technology relates to systems, devices and methods for degrading sugar using light energy.

### BACKGROUND

Photocatalytic degradation of sugar, such as glucose and sucrose, with a metal catalyst, such as titanium dioxide and zinc oxide, can convert sugar to degradation products, such as oxidized sugars, acids, aldehydes, and ketones. This process can be useful in producing these chemicals having industrial applications, or purifying liquid waste having sugar contaminants.

### SUMMARY

The present technology provides systems, devices and methods to photocatalytically degrade a sugar, i.e., degrading a sugar into degradation products using a light energy, such as solar energy or energy from manmade light sources. Photocatalytic degradation of a sugar not only produces degradation products, such as acids (or salts thereof), aldehydes, ketones, hydrogen and compounds wherein one or more of the hydroxy groups of the sugar are oxidized to ketone groups (also referred to as oxidized sugar), that are useful chemicals in the chemical industry, but also collects and stores the light energy in one or more of the degradation products in the form of chemical energy, which can be readily stored and transported. The present technology uses a photonic antenna molecule, such as fluorescein, to collect a light energy. The photonic antenna molecule then transfers the energy to a catalyst, such as metal nanoparticles, which, in turn, catalyzes degradation of a sugar to one or more degradation products, for example, acids (including salts thereof), aldehydes, ketones or oxidized sugars, using the light energy.

In one aspect, the present technology provides a system for photocatalytically degrading a sugar. The system comprises at least one photonic antenna molecule and at least one catalyst. The photonic antenna molecule is capable of collecting a light energy and transferring the light energy to the catalyst; and the catalyst is capable of degrading the sugar to produce at least one degradation product with the energy obtained from the photonic antenna molecule.

In another aspect, this technology provides a device for photocatalytically degrading a sugar. The device has a reaction chamber that contains a photocatalytic degrading system as described above.

In another aspect, this technology provides a method for photocatalytically degrading a sugar by illuminating a light on a photocatalytic degrading system that is in contact with the sugar. The photocatalytic degrading system contains at least one photonic antenna molecule; and at least one catalyst. The photonic antenna molecule collects the energy of the light and transfers the energy to the catalyst. The catalyst then degrades the sugar to produce at least one degradation product with the energy of the light.

In yet another aspect, the present technology provides a method for photocatalytically degrading a sugar by illuminating a light on a device for photocatalytically degrading the sugar. The device has a reaction chamber which contains a translucent surface, a sugar, and a photocatalytic degrading system. The photocatalytic degrading system contains at least one photonic antenna molecule and at least one catalyst. The photonic antenna molecule is capable of collecting the energy of the light and transferring the energy of the light to the catalyst; and the catalyst is capable of degrading the sugar to produce at least one degradation product.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWING

FIG. 1 is a schematic illustration of an exemplary device for photocatalytically degrading a sugar.

### DETAILED DESCRIPTION

The illustrative embodiments described in the detailed description and claims are not meant to be limiting. Other embodiments may be used, and other changes may be made, without departing from the spirit or scope of the subject matter presented here.

The present technology is described herein using several definitions, as set forth throughout the specification.

As used herein, unless otherwise stated, the singular forms “a,” “an,” and “the” include plural reference. Thus, for example, a reference to “a photonic antenna molecule” includes a plurality of photonic antenna molecules.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

Photonic antenna molecule refers to a light sensitive molecule that is capable of collecting a light energy and transferring the collected light energy to another molecule, such as a catalyst useful in photocatalytic degradation of sugar.

Catalyst refers to a substance, such as a metal nanoparticle (MNP), which can be excited to an excited state from an unexcited state by an energy. The substance in the excited state is capable of catalyzing degradation of a sugar with the energy. After catalyzing degradation of the sugar, the substance returns to the unexcited state where it can be excited again by an energy.

Sugar refers to a monosaccharide, disaccharide or polysaccharide.

C₁-C₆ alkyl refers to a monovalent saturated aliphatic hydrocarbyl group having from 1 to 6 carbon atoms. This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—).

Aldehyde refers to an alkane (a partially unsaturated or saturated hydrocarbon compound) substituted with at least one formyl (C(═O)H) group. Examples of aldehydes include but are not limited to formaldehyde, acetaldehyde, malondialdehyde and glyoxal, etc.

Alcohol refers to an alkane substituted with at least one hydroxy (OH) group. If an alcohol contains two or more hydroxy groups, the hydroxy groups are on different carbon atoms. Examples of alcohols include but are not limited to methanol, ethanol, propanol, butanol and hexanol, etc.

Carboxylic acid refers to an alkane substituted with at least one carboxy (CO₂H) group, and optionally substituted with a hydroxy or an oxo (═O) group. Examples of carboxylic acids include but are not limited to acetic acid, glycolic acid, lactic acid, pyruvic acid, and glyconic acid, etc. Salts of an acid include, but are not limited to, salts with alkali metal ions, alkaline earth ions, ammonium ion, or combinations thereof. In some embodiments, a salt of an acid is any of Na⁺, K⁺, Ca²⁺, Mg²⁺, NH₄⁺ salt, or a combination thereof.

Ketone refers to an alkane wherein at least one of the methylene group (CH₂) is replaced with a carbonyl (CO) group, wherein the methylene is not at the end of the molecule. Examples of ketones include but are not limited to acetone and acetylacetone, etc.

Oxidized sugar refers to a sugar molecule wherein at least one of its hydroxy group is oxidized to a ketone group. For example, the following compounds and positional- or stereo-isomers thereof can be referred to as oxidized glucose:

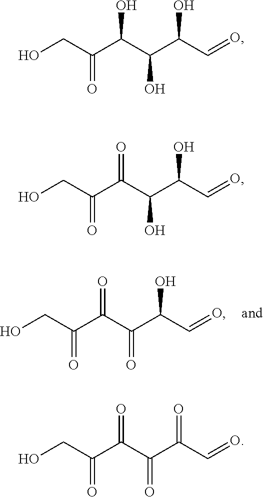

Light energy includes energy of visible, infrared and ultraviolet light. The light can have a single wavelength or a mixture of wavelengths. Examples of light energy include, but are not limited to, solar energy and energy from an artificial light. An artificial light is a light emitted from a man-made light source. Examples of man-made light sources include, but are not limited to, incandescent lightings, fluorescent lightings, high-intensity discharge (HID) lightings, low-pressure sodium lightings, gas discharge lightings (e.g., a xenon lamp), lasers, light-emitting diodes (LED), organic light emitting diodes (OLED), and ultra-violet light sources (e.g., a mercury lamp), etc.

Translucent surface refers to a surface of a device that allows at least part of a light to enter the device. Translucent surfaces include surfaces that allow all light to enter into the device, surfaces that allow a reduced amount of the light to enter the device and surfaces that allow light with one wavelength or selected wavelengths to enter the device.

### Photocatalytic Systems

In one aspect, this technology provides a system for photocatalytically degrading a sugar. The system comprises at least one photonic antenna molecule, and at least one catalyst. The photonic antenna molecule is capable of collecting a light energy and transferring the light energy to the catalyst; and the catalyst is capable of degrading the sugar to produce at least one degradation product with the energy obtained from the photonic antenna molecule.

Not wishing to be bound by theory, in this photocatalytic degrading system, the photonic antenna molecule collects a light energy that illuminates on it and is being excited to an excited state by the light energy. The photonic antenna molecule then transfers the light energy to the catalyst. Upon the energy transfer, the photonic antenna molecule returns to its original unexcited state and can collect another light energy, while the catalyst is excited to an excited state. The photonic antenna molecule and the catalyst of the system are not covalently bound, but are in close proximity so that light energy collected by the photonic antenna molecule can be transferred to the catalyst. The energy collected by the photonic antenna molecule can be transferred to the catalyst completely or partially. In one embodiment, the catalyst is excited solely through energy transfer. In another embodiment, the catalyst is excited through electron transfer to the photonic antenna molecule (electron transfer-oxidation of the catalyst). In yet another embodiment, the catalyst is excited through electron transfer from the photonic antenna molecule (electron transfer-reduction of the catalyst). The catalyst in the excited state then catalyzes degradation of a sugar with the energy it obtained from the photonic antenna molecule. After catalyzing degradation of the sugar, the catalyst returns to the unexcited state and is capable of receiving an energy that has been collected by a photonic antenna molecule and being excited again by the energy.

In some embodiments, the photonic antenna molecule is selected from 5-hydroxytryptamine, acridines, Alexa Fluor® type, ATTO, BODIPY® (boron-dipyrromethene) type, Coumarin 6, CY (cyanine) type, DAPI (4′,6-diamidino-2-phenylindole) type, ethidium compounds (such as ethidium bromide (3,8-diamino-5-ethyl-6-phenylphenanthridinium bromide)), Hoechst type, Oregon Green, rhodamine, compounds comprising Ru(bpy)₃²⁺ (bpy=bipyridine), compounds comprising Pt₂(P₂O₅H₂)⁴⁻(Pt₂(pop)₄⁴⁻), YOYO type, and SeTau type, and a mixture thereof. Such photonic antenna molecules are generally available from commercial sources such as Sigma-Aldrich Co. LLC, USA, Life Technologies, New York, USA, ATDBio Ltd., UK, ATTO-TEC GmbH, Germany, Hoechst AG, Germany, and SETA BioMedicals, IL, USA.

ATTO type of photonic antenna molecules include, but are not limited to, ATTO 390, ATTO 425, ATTO 465, ATTO 488, ATTO 495, ATTO 520, ATTO 532, ATTO 550, ATTO 565, ATTO 590, ATTO 594, ATTO 610, ATTO 611X, ATTO 620, ATTO 633, ATTO 635, ATTO 637, ATTO 647, ATTO 647N, ATTO 655, ATTO 665, ATTO 680, ATTO 700, ATTO 725 and ATTO 740.

Acridines include, but are not limited to, N,N,N′,N′-tetramethylacridine-3,6-diamine (Acridine orange), 2,7-dimethylacridine-3,6-diamine (acridine yellow), 9-bromoacridine, 9-chloroacridine, 2-hydroxy-10H-acridin-9-one, 9-aminoacridine, 9,10-dihydroacridine, 9-amino-1,2,3,4-tetrahydroacridine, 6,9-dichloro-2-methoxyacridine, 9-acridinecarboxylic acid, 1,3-dihydroxy-9-acridinecarboxylic acid, 9-hydroxy-4-methoxyacridine, 1,2,3,4-tetrahydro-9-acridinecarboxylic acid, 2-methyl-9-acridinecarboxaldehyde, 6,9-diamino-2-ethoxyacridine-DL-lactate, 7,10-dimethylbenz[c]acridine, and 7,9-dimethylbenz[c]acridine, and salts thereof.

Alexa Fluor type of photonic antenna molecules include, but are not limited to, Alexa Fluor® 350, Alexa Fluor® 405, Alexa Fluor® 430, Alexa Fluor® 488, Alexa Fluor® 500, Alexa Fluor® 514, Alexa Fluor® 532, Alexa Fluor® 546, Alexa Fluor® 555, Alexa Fluor® 568, Alexa Fluor® 594, Alexa Fluor® 610, Alexa Fluor® 633, Alexa Fluor® 647, Alexa Fluor® 660, Alexa Fluor® 680, Alexa Fluor® 700 and Alexa Fluor® 750.

BODIPY® type of photonic antenna molecules include, but are not limited to, BODIPY® 493/503, BODIPY® FL-X, BODIPY® FL, BODIPY® R6G, BODIPY® 500/510, BODIPY® 530/550, BODIPY® TMR-X, BODIPY® 558/568, BODIPY® 564/570, BODIPY® 576/589, BODIPY® 581/591, BODIPY® TR-X, BODIPY® 630/650-X, and BODIPY® 650/665-X.

CY type of photonic antenna molecules include, but are not limited to, Cy2, Cy3, Cy3B, Cy3.5, Cy5, Cy5.5, Cy7, and Cy7.5, including NHS esters and azides.

Hoechst type of photonic antenna molecules include, but are not limited to, Hoechst 33342, Hoechst 33258, and Hoechst 34580.

Oregon Green type of photonic antenna molecules are fluorinated analogs of fluoresceins, which include, but are not limited to, Oregon Green 488, Oregon Green 500 and Oregon Green 514.

Rhodamine type of photonic antenna molecules include, but are not limited to, rhodamine 6G, rhodamine 101, rhodamine 110, rhodamine 123, rhodamine B, 5(6)-carboxy-X-rhodamine, 5(6)-carboxy-X-rhodamine N-succinimidyl ester, 5(6)-carboxytetramethylrhodamine, 5(6)-carboxytetramethylrhodamine N-succinimidyl ester, 5-carboxy-X-rhodamine N-succinimidyl ester, 5-carboxy-tetramethylrhodamine N-succinimidyl ester, 5-carboxytetramethylrhodamine, 6-carboxy-tetramethylrhodamine N-succinimidyl ester, 6-carboxytetramethylrhodamine, N-(2-aminoethyl)rhodamine 6G-amide bis(trifluoroacetate), N-(6-aminohexyl)rhodamine 6G-amide bis(trifluoroacetate), N-(8-amino-3,6-dioxaoctyl)rhodamine 6G-amide bis(trifluoroacetate), N-[2-(2-aminoethylamino)ethyl[rhodamine 6G-amide bis(trifluoroacetate), N-[4-(aminomethyl)benzyl]rhodamine 6G-amide bis(trifluoroacetate), N-[trans-4-(succinimidyloxycarbonyl)cyclohexylmethyl]-sulforhodamine B-acid amide, rhodamine B isothiocyanate, sulforhodamine 101 acid chloride, sulforhodamine B acid chloride, tetramethylrhodamine isothiocyanate, tetramethylrhodamine-5-maleimide, and tetramethylrhodamine-6-maleimide.

Compounds comprising Ru(bpy)₃²′ include, but are not limited to, Ru(bpy)₃Cl₂, Ru(bpy)₃(ClO₄)₂, Ru(bpy)₃[PF₆]₂, and Ru(bpy)₂(dcpby)[PF₆]₂ (dcpby=4,4′-dicarboxy-2,2′-bipyridyl). Compounds comprising Pt₂(P₂O₅H₂)⁴⁻(Pt₂(pop)₄⁴⁻) include, but are not limited to, K₄Pt₂(pop)₄, and (NH₄)₄Pt₂(pop)₄.

YOYO type of photonic antenna molecules are dimeric cyanine compounds which include, but are not limited to, YOYO-1 and YOYO-3.

SeTau type of photonic antenna molecules include, but are not limited to, SeTau-647, SeTau-655, SeTau-665, SeTau-380-NHS, SeTau-404-NHS, SeTau-405-NHS, and SeTau-425-NHS.

In some embodiments, the photonic antenna molecule is 5-hydroxytryptamine, ATTO 565, ATTO 655, Acridine Orange, Acridine Yellow, Alexa Fluor® 488, Alexa Fluor® 532, Alexa Fluor® 546, Alexa Fluor® 633, Alexa Fluor® 647, Alexa Fluor® 680, BODIPY® 500/510, BODIPY® 530/550, BODIPY® FL, BODIPY® TR-X, Cascade Blue® (pyrenyloxytrisulfonic acid), Coumarin 6, CY2, CY3B, CY3, CY3.5, CY5, CY5.5, Dansyl, 5-(dimethylamino)naphthalene-1-sulfonamide, DAPI, 1,6-diphenyl-1,3,5-hexatriene (DPH), 2-(6-hydroxy-2,4,5,7-tetraiodo-3-oxo-xanthen-9-yl)benzoic acid (erythrosine), 3,8-diamino-5-ethyl-6-phenylphenanthridinium bromide (ethidium bromide), fluorescein isothiocyanate (FITC), fluorescein, 2-[6-[bis(carboxymethyl)amino]-5-[2-[2-[bis(carboxymethyl)amino]-5-methylphenoxy]ethoxy]-1-benzofuran-2-yl]-1,3-oxazole-5-carboxylic acid (FURA-2), green fluorescent protein (GFP), Hoechst 33258, Hoechst 33342, 8-hydroxypyrene-1,3,6-trisulfonic acid (HPTS) or a salt, sodium 4-[2-[(1E,3E,5E,7Z)-7-[1,1-dimethyl-3-(4-sulfonatobutyl)benzo[e]indol-2-ylidene]hepta-1,3,5-trienyl]-1,1-dimethylbenzo[e]indol-3-ium-3-yl]butane-1-sulfonate (Indocyanine Green), 6-dodecanoyl-2-dimethylaminonaphthalene (Laurdan), 6-amino-2,3-dihydro-1,3-dioxo-2-hydrazinocarbonylamino-1H-benz[d,e]isoquinoline-5,8-disulfonic acid dilithium salt (Lucifer Yellow), 9-diethylamino-5-benzo[α]phenoxazinone (Nile Red), Oregon Green 488, Oregon Green 500, Oregon Green 514, 6-propionyl-2-dimethylaminonaphthalene (Prodan), pyrene, Rhodamine 101, Rhodamine 110, Rhodamine 123, Rhodamine 6G, Rhodamine B, Ru(bpy)₃[PF₆]₂, Ru(bpy)₂(dcpby)[PF₆]₂, SITS, SNARF, Stilbene SITS, SITA, sulforhodamine 101 acid chloride (Texas Red), TOTO-1, YOYO-1, YOYO-3, or a mixture thereof.

In some embodiments, the photonic antenna molecule is fluorescein, a fluorescein salt or a fluorescein derivative. Fluorescein is of the formula:

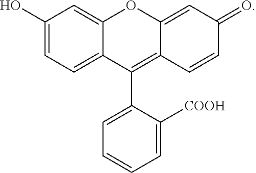 [SMILES: O=C(O)c1ccccc1-c1c2ccc(=O)cc-2oc2cc(O)ccc12]

Salts of fluorescein include, but are not limited to, the sodium salt and disodium salt.

There are many fluorescein derivatives. For example, 1-(O′-methylfluoresceinyl)piperidine-4-carboxylic acid, 2′,7′-dichlorofluorescein diacetate, 5(6)-carboxyfluorescein, 5(6)-carboxyfluorescein diacetate, 5(6)-carboxyfluorescein diacetate N-succinimidyl ester, 5-(bromomethyl)fluorescein, 5-(iodoacetamido)fluorescein, 5-([4,6-dichlorotriazin-2-yl]amino)fluorescein hydrochloride, 5-carboxy-fluorescein diacetate N-succinimidyl ester, 5-carboxyfluorescein, 5-carboxyfluorescein N-succinimidyl ester, 6-carboxy-fluorescein diacetate N-succinimidyl ester, 6-[fluorescein-5(6)-carboxamido]hexanoic acid, 6-[fluorescein-5(6)-carboxamido]hexanoic acid N-hydroxysuccinimide ester, 6-carboxy-4′,5′-dichloro-2′,7′-dimethoxyfluorescein N-hydroxysuccinimide ester, 6-carboxyfluorescein, 2′,4′,5′,7′-tetrabromofluorescein disodium salt, fluorescein 5(6)-isothiocyanate, fluorescein diacetate 5-maleimide, fluorescein diacetate 6-isothiocyanate, fluorescein isothiocyanate, fluorescein mercuric acetate, fluorescein 5-carbamoylmethylthiopropanoic acid N-hydroxysuccinimide ester, fluorescein-O′-acetic acid, O′-(carboxymethyl)fluoresceinamide, which are available from Sigma-Aldrich Co., Missouri, USA. Additional fluorescein derivatives include 2′,7′-difluorofluorescein (OREGON GREEN™), 5-[4-benzoic acid]-10,15,20-tris[3,5-di-tert-butylphenyl]-21H,23H-porphyrin, and 9-[2-(3-carboxy-9,10-diphenyl)anthryl]-2,7-difluoro-6-hydroxy-3H-xanthen-3-one, Taku Hasobe, et al., Chemical Physics, 319 (2005) 243-252.

In some embodiments, the catalyst is a metal nanoparticle. In some embodiments, the nanoparticle has a size of between about 5 nanometer (nm) to about 10 micron, or to about 1 micron, or to about 500 nm, or to about 200 nm, or between about 10 nm to about 100 nm, or between about 10 nm to about 50 nm. Specific examples of sizes include about 5 nm, about 10 nm, about 15 nm, about 20 nm, about 50 nm, about 100 nm, about 500 nm, about 1 micron, about 10 micron, and ranges between any two of these values (including endpoints).

The metal nanoparticle catalyst Mₙ can comprise the same or a mixture of different metals M and different values for n, wherein M represents a metal atom and n represents the approximate numbers of atoms in the nanoparticle. The number of atoms in a nanoparticle will depend on a number of factors such as the size of the nanoparticle, the size of the metal atom, the distances between atoms, etc. In one embodiment, n is an integer number between 4 and 3×10¹¹, such as 4, 10, 100, 300, 500, 1000, 3000, 5000, 10⁴, 3×10⁴, 5×10⁴, 10⁵, 3×10⁵, 5×10⁵, 10⁶, 3×10⁶, 5×10⁶, 10⁷, 3×10⁷, 5×10⁷, 10⁸, 3×10⁸, 5×10⁸, 10⁹, 3×10⁹, 5×10⁹, 10¹⁰, 3×10¹⁰, 5×10¹⁰, 10¹¹, and 3×10¹¹, and ranges between any two of these values (including endpoints). In some embodiments, M is a noble metal, such as gold, silver, platinum, palladium, iridium, rhodium, osmium, ruthenium, or similar metals. In some embodiments, M is a lighter transition and post-transition metal, such as copper, nickel, cobalt, iron, or similar metals. In some embodiments, M is a lanthanide metal, namely, any of lanthanum, cerium, praseodymium, neodymium, promethium, samarium, europium, gadolinium, terbium, dysprosium, holmium, erbium, thulium, ytterbium and lutetium. Partially oxidized metal nanoparticles such as nickel/nickel oxide, copper/copper oxide, silver/silver oxide, ruthenium/ruthenium oxide, and europium/europium oxide can also be used. In some embodiments, M is a mixture of two or more of the metals. Metal nanoparticles can be prepared by methods known in the art.

In some embodiments, the catalyst comprises ruthenium, palladium, gold, silver, nickel, tungsten, molybdenum, gallium or platinum, or a mixture thereof. In some embodiments, the catalyst comprises palladium-doped ZnO.

In some embodiments, the catalyst is a nanoparticle comprising a ruthenium (II) complex or diplatinum (II) complex, such as a water-insoluble salt of the complex. Water-insoluble when defining a substance means that the substance has a solubility in water of no more than 10 milligram (mg) per liter, no more than 1 mg per liter, or more than 0.1 mg per liter. In some embodiments, the catalyst is a nanoparticle comprising tris(2,2′-bipyridine)ruthenium(2⁺) (Ru(bpy)₃²⁺). Ru(bpy)₃²⁺ is of the formula:

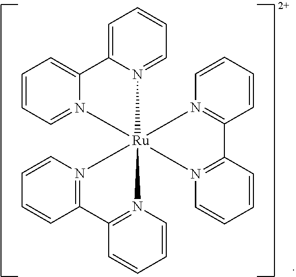

In some embodiments, the catalyst is a nanoparticle comprising Pt₂(P₂O₅H₂)⁴⁻(Pt₂(pop)₄⁴⁻). Ru(bpy)₃²⁺ and Pt₂(pop)₄⁴⁻ have been used in photo-splitting of water. Their activity can be enhanced when in the form of nanoparticles due to their nanoparticle size.

In some embodiments, the catalyst is a nanoparticle of a water-insoluble salt of the complex with a non-photoactive counterion. Suitable counterions include, among others, large or highly charged ions. Non-limiting examples of negative conterions include hexafluorophosphate (PF₆), tetraphenylborate (B(C₆H₅)₄⁻), sulfate (SO₄²⁻) and phosphate (PO₄³⁻) Non-limiting examples of positive conterions include Cs⁺, Ba²⁺, tetraphenylphosphonium (P(C₆H₅)₄⁺), and bis-(triphenylphosphine) iminium ((C₆H₅)₃P)₂N⁺). Examples of non-photoactive cation/anion combinations include [Ru(bpy)₃²⁺][PF₆]₂, [Ru(bpy)₃²⁺][B(C₆H₅)₄⁻]₂, [Ru(bpy)₃²⁺][SO₄²⁻], [Ru(bpy)₃²⁺]₃[PO₄³⁻]₂, Ba²⁺₂[Pt₂(pop)₄⁴⁻], Cs⁺₄[Pt₂(pop)₄⁴⁻], [P(C₆H₅)₄⁺]₄[Pt₂(pop)₄⁴⁻], and [((C₆H₅)₃P)₂N⁺]₄[Pt₂(pop)₄⁴⁻].

In some embodiments, the catalyst is a nanoparticle of a water-insoluble salt of the complex with a photoactive counterion. Non limiting examples of photoactive cations and anions include the ionic photonic antenna molecules described herein. Examples of photoactive [cation][anion] combinations include, but are not limited to, [Ru(bpy)₃²⁺][fluorescein⁻]₂, [Ru(bpy)₃²⁺][1-(O′-methylfluoresceinyl)piperidine-4-carboxylate⁻]₂, [Ru(bpy)₃²⁺][Alexa Fluor® 350⁻]₂, [Ru(bpy)₃²⁺]₅[FURA 2⁵⁺]₂, [Ru(bpy)₃²⁺][6-amino-2,3-dihydro-1,3-dioxo-2-hydrazinocarbonylamino-1H-benz[d,e]isoquinoline-5,8-disulfonic acid anion²⁻], [3,8-Diamino-5-ethyl-6-phenylphenanthridinium bromide⁺]₄[Pt₂(pop)₄⁴⁻], [YOYO-1⁴⁺][Pt₂(pop)₄⁴⁻], [Hoechst 34580³⁺]₄[Pt₂(pop)₄⁴⁻]₃, and [rhodamine B⁺]₄[Pt₂(pop)₄⁴⁻].

In some embodiments, the catalyst is a nanoparticle of a double salt formed between these metal complex ions, such as [Ru(bpy)₃²⁺]₂[Pt₂(pop)₄⁴⁻].

The water-insoluble salt nanoparticles can be formed using the wet precipitation method. For example, nanoparticles of [Ru(bpy)₃²⁺]₂[Pt₂(pop)₄⁴⁻] can be prepared by mixing a solution of soluble salts of the metal complexes, such as Ru(bpy)₃Cl₂ and Na₄Pt₂(pop)₄, to form a solid precipitation. The solid precipitation can be optionally filtered, washed, and optionally dried. The nanoparticle of the insoluble salt can then be used as catalyst. In some embodiments, photonic antenna molecules can be dissolved in the solution or attached onto a support (such as a polymer support described herein) and used with the nanoparticles of a water-insoluble salt of the metal complex to form the photocatalytic degrading system. In some embodiments, the salt nanoparticle is both the photonic antenna molecule and the catalyst in the photocatalytic degrading system.

In some embodiments, the system does not contain Rh—Cr₂O₃, Cr₂O₃, TiO₂, Co₃O₄, RuO₂, CaMn₃O₄, or IrO₂. In some embodiments, the system does not contain Rh—Cr₂O₃, BiVO₄, Pt—SrTiO₃, Pt—WO₃, WO₃, Cr₂O₃, TiO₂, Co₃O₄, RuO₂, CaMn₃O₄, or IrO₂. In some embodiments, the system does not contain a metal oxide.

In some embodiments, the sugar is glucose, fructose, galactose, sucrose, xylose, ribose, lactose, maltose, lactulose, trehalose, cellobiose, starch, amylose, amylopectin, glycogen, cellulose, chitin, or a mixture thereof.

The amount of the photonic antenna molecule and catalyst can be any suitable amount. In some embodiments, the ratio of the photonic antenna molecule and the catalyst is from about 0.1:1 to about 10:1 weight/weight. In some embodiments, the ratio of the photonic antenna molecule and the catalyst is from about 0.1:1, 0.2:1, 0.5:1, 1:1, 2:1, 5:1, or 10:1 weight/weight, and ranges between any two of these values (including endpoints). In some embodiments, the amount of the photonic antenna molecule is from about 0.1% equivalent to about 1 equivalent of the amount of the sugar. In some embodiments, the amount of the photonic antenna molecule is from about 0.5% to about 50%, about 1% to about 20%, or about 5% to about 10% equivalent of that of the amount of the sugar. In some embodiments, the equivalent of the photonic antenna molecule to the sugar is about 0.1%, 0.5%, 1%, 2%, 5%, 10%, 20%, 50%, or 100%, and ranges between any two of these values (including endpoints).

In some embodiments, the degradation product is a carboxylic acid or a salt thereof, an aldehyde, a ketone, an alcohol, an oxidized sugar, or a mixture thereof. In some embodiments, the degradation product is RCO₂H, RCOH, ROH, or RCOR′, or a mixture thereof, wherein R and R′ are independently C₁-C₆ alkyl. In some embodiments, the degradation product is an oxidized sugar. In some embodiments, the degradation product is acetic acid, acetaldehyde, malondialdehyde, glyoxal, iso-propanol, 1,2-propanediol, isopentanol, pentanol, glycolic acid, lactic acid, pyruvic acid, lactic acid, succinic acid, formic acid, glyconic acid, butyric acid, propanoic acid, valeric acid, acetone, ethanol, a butanol (ROH, wherein R is C₄ alkyl), a hexanol (ROH, wherein R is C₆ alkyl), or a salt thereof, or a mixture thereof. Hydrogen (H₂) may also be produced as a degradation product.

In some embodiments, the sugar and the photonic antenna molecule are dissolved in water to form an aqueous solution and the catalyst is suspended in the aqueous solution. The solution may be stirred to facilitate (1) contact of the photonic antenna molecule with the catalyst and transfer of energy from the photonic antenna molecule to the catalyst; and (2) contact of the catalyst with the sugar to facilitate degradation of the sugar catalyzed by the catalyst. In some embodiments, the photonic antenna molecule is distributed within a polymer. In some embodiments, the polymer is polycarbonate or polyethylene.

In some embodiments, the light energy is from a natural light, such as sunlight. In some embodiments, the light energy is from an artificial light. In some embodiments, the light energy is the energy of a light emitted from an incandescent lighting, a fluorescent lighting, a high-intensity discharge (HID) lighting, a low-pressure sodium lighting, a light-emitting diode (LED), or an organic light emitting diode (OLED). In some embodiments, the light source is from a gas discharge lighting, such as an argon, neon, krypton or xenon lamp. In some embodiments, the light is laser, such as gas laser (e.g., helium-neon laser, carbon dioxide laser, or argon-ion laser), chemical laser (e.g., hydrogen fluoride laser or deuterium fluoride laser), excimer laser, solid-state laser, fiber laser, semiconductor laser, free electron laser, and bio laser. In some embodiments, the laser is a continuous laser or a pulsed laser. In some embodiments, the light source is an ultraviolet light source, such as a mercury lamp.

### Illustrative Devices

In another aspect, this present technology provides a device for photocatalytically degrading a sugar. The device has a reaction chamber that contains a photocatalytic degrading system as described herein.

In some embodiments, the reaction chamber further contains a translucent surface. The translucent surface may be made of glass or a plastic material, such as polyethylene, polypropylene, or polycarbonate.

In some embodiments, one or both of the photonic antenna molecule and the catalyst of the photocatalytic degrading system is coated on or attached to the translucent surface. In some embodiments, the photonic antenna molecule is attached to the translucent surface by melting or by use of a thin coating of a colorless adhesive. Possible adhesives include, but are not limited to, colorless epoxy cements, acrylic polymers such as cyanoacrylates, polyurethanes, and similar formulations. In some embodiments, the catalyst is attached to the photonic antenna molecule by softening the molecule by, for example, heating the support material to just below its melting point, or by use of a thin coating of a colorless adhesive. Possible support materials for the photonic antenna molecule and the catalyst include, but are not limited to, polyethylene, polypropylene, polyesters, polycarbonates, polyimides, and similar formulations.

In some embodiments, the photocatalytic degrading system is present in an aqueous solution. The photonic antenna molecule may be dissolved in the aqueous solution and the catalyst may be suspended in the aqueous solution.

In some embodiments, the device further comprises a sugar. In some embodiments, the sugar is present as an aqueous solution.

In some embodiments, the reaction chamber may have an inlet, and the device is configured such that the sugar enters the reaction chamber through the inlet. In some embodiments, the reaction chamber may have an outlet and the device is configured such that one or more of the degradation products exit the chamber through the outlet. The device may have multiple outlets for different degradation products. For example, the gaseous degradation products, such as hydrogen, may exit through one outlet. Liquid or water soluble degradation products, such as oxidized sugar, ketone or aldehyde, may exit through another outlet. Unconsumed sugar may also exit with the aqueous solution comprising the water soluble degradation products. In one embodiment, the device is configured such that the sugar that is not degraded is re-circulated through the reaction chamber. In this embodiment, the device may comprise a passage connecting the outlet through which the unconsumed sugar exits the reaction chamber and the inlet through which the sugar enters into the reaction chamber. In one embodiment, the device comprises a separation apparatus to separate the unconsumed sugar from the degradation products, for example, by extracting the mixture with an organic solvent that dissolves the degradation products but not the sugar, such as ethyl acetate. The organic portion having the degradation product can be separated from the aqueous portion having the sugar by partition.

In some embodiments, a light is illuminated on the translucent surface.

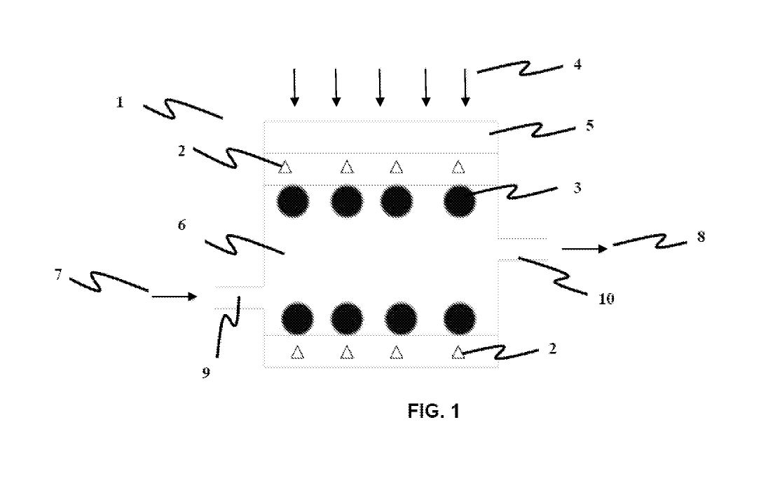

FIG. 1 is a schematic illustration of an exemplary embodiment of a device of the present technology. In FIG. 1, device 1 has a translucent surface 5 and a reaction chamber 6. Photonic antenna molecules 2 are attached to translucent surface 5 and metal nanoparticles 3 are in proximity to photonic antenna molecules 2. Device 1 further has an inlet 9 and an outlet 10. A sugar solution 7 enters chamber 6 through inlet 9. Light 4 illuminates translucent surface 5 and its energy is collected by photonic antenna molecules 2. Photonic antenna molecules 2 transfer the collected energy to metal nanoparticles 3 which are excited to an excited state by the energy. The excited metal nanoparticles 3 degrade the sugar in sugar solution 7 into degradation products 8, which exit chamber 6 through outlet 10. While not illustrated, outlet 10 optionally connects to a collecting apparatus, such as a container, for collecting and storing the degradation products, a separation or purification apparatus for isolating the degradation products from the aqueous solution, or a transporting apparatus, such as a pipe or a transportation vehicle, such as a tank of a truck, etc., for transporting the degradation products to a desired destination.

### Methods

In one of its method aspects, this technology provides a method for photocatalytically degrading a sugar by illuminating a light on a photocatalytic degrading system that is in contact with the sugar. The photocatalytic degrading system contains at least one photonic antenna molecule and at least one catalyst. The photonic antenna molecule collects the energy of the light and transfers the energy to the catalyst. The catalyst then degrades the sugar to produce at least one degradation product with the energy of the light.

In some embodiments, the photocatalytic degrading system used in the method is as described herein.

In some embodiments, the sugar is present in an aqueous solution. The aqueous solution is in contact with the catalyst of the photocatalytic degrading system. In some embodiments, the photonic antenna molecule is dissolved in the aqueous solution and the catalyst is suspended in the aqueous solution. In some embodiments, the solution is stirred, or agitated to facilitate contact of the catalyst with the photonic antenna molecule, and contact of the sugar with the catalyst.

In another aspect, the present technology provides a method for photocatalytically degrading a sugar by illuminating a light on a device for photocatalytically degrading the sugar. The device has a reaction chamber which contains a translucent surface, a sugar, and a photocatalytic degrading system. The photocatalytic degrading system contains at least one photonic antenna molecule and at least one catalyst. The photonic antenna molecule is capable of collecting the energy of the light and transferring the energy of the light to the catalyst; and the catalyst is capable of degrading the sugar to produce at least one degradation product.

In some embodiments, the device is a device described herein and the photocatalytic degrading system is as described herein.

In some embodiments, the degradation is conducted in a continuous manner. For example, the sugar solution can enter the reaction chamber of the device constantly or periodically at a certain speed, and the degradation products can exit the reaction chamber at a corresponding speed so that a desired amount of the sugar solution is present in the reaction chamber for photocatalytic degradation within an entire operation period.

In some embodiments, the degradation of the sugar is conducted at a temperature of between the boiling point and the freezing point of the sugar aqueous solution. For example, the temperature is between about 0° C. and about 100° C. In some embodiments, the temperature is between about 15° C. and about 80° C., or between about 20° C. and about 60° C. In some embodiments, the temperature is between about 20° C. and about 50° C. Specific examples of temperatures include about 20° C., about 30° C., about 40° C., about 50° C., and ranges between any two of these values (including endpoints).

The progress and/or completion of the degradation can be monitored by analytical methods, such as high performance liquid chromatography (HPLC), thin layer chromatography (TLC), mass spectrometry (MS), gas chromatography (GC) and HPLC-MS, etc. The degradation products, such as oxidized sugars, acids or salts thereof, aldehydes, ketones and alcohols, can be separated and purified from the reaction mixture by separation methods, such as extraction, distillation and liquid chromatography, etc. Gaseous degradation products, such as hydrogen, can be collected using a gas impermeable container connected to the degradation reaction apparatus. The insoluble components of the photocatalytic degrading system, such as the metal nanoparticles, can be recovered from the reaction mixture by methods such as filtration, centrifugation, and decantation, etc. The soluble components of the photocatalytic degrading system, such as soluble photonic antenna molecules, can be recovered from the reaction mixture by methods such as evaporation of solvent, extraction, liquid chromatography, etc.

Scheme 1 illustrates degradation of glucose by a system having fluorescein as the photonic antenna molecule and metal nanoparticle Mₙ as the catalyst, wherein M and n are as defined herein. In scheme 1, light energy (hv) is collected by fluorescein and transferred to metal nanoparticle Mₙ. Mₙ is excited to an excited state Mₙ*. The Mₙ* then catalyzes degradation of glucose to degradation products as shown in Scheme 1, which can be further degraded to other degradation products including acetone, acetaldehyde and hydrogen, etc., with the energy originated from the light energy. As a result, Mₙ* returns to unexcited Mₙ, which is capable of being excited again by fluorescein after fluorescein collects a light energy.

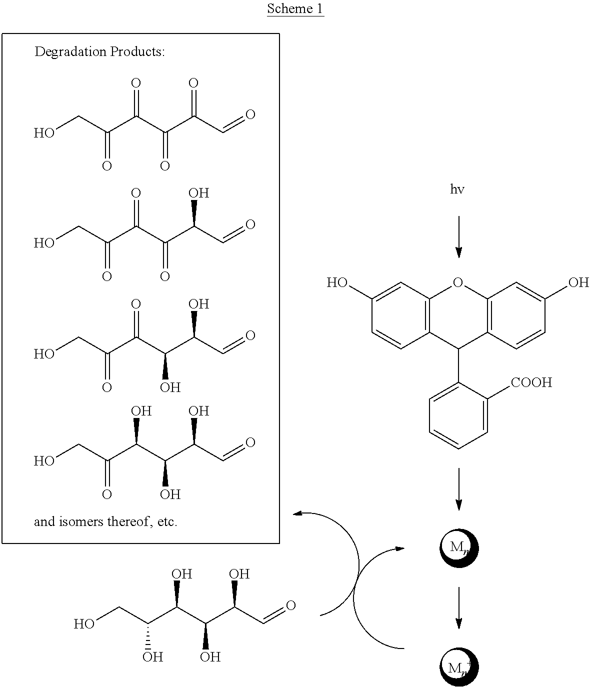

The following examples more specifically illustrate certain embodiments described above. These examples should in no way be construed as limiting the scope of the present technology.

### Example 1

### Photocatalytic Degradation of Glucose

Ten (10) grams of glucose (55 micromole (mmol), 1 equivalent) is dissolved in 100 milliliter (mL) of water to form a glucose aqueous solution. To the glucose aqueous solution is added 100 mg of fluorescein (0.3 mmol, 0.005 equivalent) and 100 mg of platinum nanoparticles having sizes of between about 10 to about 100 nm. The mixture is stirred at ambient temperature while a visible light such as a xenon lamp is illuminated onto the solution. The sugar content in the aqueous solution is monitored by high performance liquid chromatography (HPLC). Upon complete consumption of the glucose, the mixture is centrifuged to remove the platinum nanoparticles. The supernatant is distilled to give acetone, formaldehyde or other volatile organic products. Fluorescein is recovered by evaporating the solvent. The recovered fluorescein and platinum nanoparticles may be added to another sugar aqueous solution to catalyze sugar degradation.

### Example 2

### Photocatalytic Degradation of Sucrose

Ten (10) grams of sucrose is dissolved in 100 mL of water to form a sucrose aqueous solution. To the sucrose aqueous solution is added 100 mg of rhodamine 6G and 100 mg of nickel nanoparticles having sizes of between about 100 to about 500 nm. The mixture is stirred at ambient temperature while an ultra-violet light such as a mercury lamp is illuminated onto the solution. The sugar content in the aqueous solution is monitored by high performance liquid chromatography (HPLC). Upon complete consumption of the sucrose, the mixture is centrifuged to remove the nickel nanoparticles. The supernatant is distilled to give acetone, formaldehyde or other volatile organic products. Rhodamine is recovered by evaporating the solvent. The recovered of rhodamine and nickel nanoparticles may be added to another sugar aqueous solution to catalyze sugar degradation.

### Example 3

### Photocatalytic Degradation of Fructose

Ten (10) grams of fructose is dissolved in 100 mL of water to form a fructose aqueous solution. To the fructose aqueous solution is added 100 mg of acridine orange and 100 mg of europium nanoparticles having sizes of between about 10 nm to micron size. The mixture is stirred at ambient temperature while light from a pulsed laser such as a nitrogen laser is illuminated onto the solution. The sugar content in the aqueous solution is monitored by high performance liquid chromatography (HPLC). Upon complete consumption of the fructose, the mixture is centrifuged to remove the europium nanoparticles. The supernatant is distilled to give acetone, formaldehyde or other volatile organic products. Acridine orange is recovered by evaporating the solvent. The recovered acridine orange and europium nanoparticles or micron sized particles may be added to another sugar aqueous solution to catalyze sugar degradation.

### Example 4

### Photocatalytic Degradation of Fructose

Ten (10) grams of fructose is dissolved in 100 mL of water to form a fructose aqueous solution. To the fructose aqueous solution is added 100 mg of acridine orange and 100 mg of [Ru(bpy)₃²⁺]₂[Pt₂(pop)₄⁴⁻] nanoparticles having sizes of between about 10 nm to micron size. The mixture is stirred at ambient temperature while light from a pulsed laser such as a nitrogen laser is illuminated onto the solution. The sugar content in the aqueous solution is monitored by high performance liquid chromatography (HPLC). Upon complete consumption of the fructose, the mixture is centrifuged to remove the [Ru(bpy)₃²⁺]₂[Pt₂(pop)₄⁴⁻] nanoparticles. The supernatant is distilled to give acetone, formaldehyde or other volatile organic products. Acridine orange is recovered by evaporating the solvent. The recovered acridine orange and [Ru(bpy)₃²⁺]₂[Pt₂(pop)₄⁴⁻] nanoparticles or micron sized particles may be added to another sugar aqueous solution to catalyze sugar degradation.

### Example 5

### Photocatalytic Degradation of Starch

Ten (10) grams of starch is dissolved or suspended in 100 mL of water to form a starch aqueous solution/suspension. To the starch aqueous solution/suspension is added 100 mg of Ru(bpy)₃[PF₆]_{z} and 100 mg of ruthenium/ruthenium oxide nanoparticles having sizes of between about 10 nm to micron size. The mixture is stirred at 40-50° C. while sun light is illuminated onto the solution/suspension. The sugar content in the aqueous solution is monitored by high performance liquid chromatography (HPLC). Upon complete consumption of the starch, the mixture is filtered to remove the ruthenium/ruthenium oxide nanoparticles. The filtrate is distilled to give acetone, formaldehyde or other volatile organic products. Ru(bpy)₃[PF₆]₂ is recovered by evaporating the solvent. The recovered Ru(bpy)₃[PF₆]₂ and ruthenium/ruthenium oxide nanoparticles or micron sized particles may be added to another sugar aqueous solution to catalyze sugar degradation.

### EQUIVALENTS

The embodiments, illustratively described herein may suitably be practiced in the absence of any element or elements, limitation or limitations, not specifically disclosed herein. Thus, for example, the terms ‘comprising,’ ‘including,’ ‘containing,’ etc., shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Similarly, the phrase “at least about” some value such as, e.g., wt % includes at least the value and about the value. For example “at least about 1 wt %” means “at least 1 wt % or about 1 wt %.” Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. A system for photocatalytically degrading a sugar, the system comprising:
at least one photonic antenna molecule; and
at least one catalyst;
wherein the photonic antenna molecule is capable of collecting a light energy and transferring the light energy to the catalyst; and
wherein the catalyst is capable of degrading the sugar to produce at least one degradation product.

2. The system of claim 1, wherein the photonic antenna molecule is selected from the group consisting of 5-hydroxytryptamine, an acridine, an Alexa Fluor® dye, an ATTO dye, a BODIPY® dye, Coumarin 6, a CY dye, DAPI, an ethidium compound, a Hoechst dye, Oregon Green, rhodamine, a compound comprising Ru(bpy)₃²⁺, a compound comprising (Pt₂(pop)₄⁴⁻), a YOYO dye, and a SeTau dye.

3. The system of claim 1, wherein the photonic antenna molecule is fluorescein.

4. The system of claim 1, wherein the catalyst is a metal nanoparticle.

5. The system of claim 4, wherein the metal nanoparticle comprises a metal selected from the group consisting of ruthenium, palladium, gold, silver, nickel, tungsten, molybdenum, gallium, iridium, rhodium, osmium, copper, cobalt, iron, and platinum, or a mixture thereof.

6. The system of claim 4, wherein the metal nanoparticle comprises a lanthanide.

7. The system of claim 4, wherein the metal nanoparticle comprises a metal selected from the group consisting of platinum, nickel, and europium.

8. The system of claim 5, wherein the metal nanoparticle comprises palladium-doped ZnO.

9. The system of claim 5, wherein the metal nanoparticle comprises a water-insoluble salt of a ruthenium (II) complex or a diplatinum (II) complex.

10. The system of claim 1, wherein the sugar is selected from the group consisting of glucose, fructose, galactose, sucrose, xylose, ribose, lactose, maltose, lactulose, trehalose, cellobiose, starch, amylose, amylopectin, glycogen, cellulose, and chitin, or a mixture thereof.

11. The system of claim 1, wherein the degradation product is selected from the group consisting of an oxidized sugar, a carboxylic acid or a salt thereof, an aldehyde, a ketone, and an alcohol, or a mixture thereof.

12. The system of claim 1, wherein the degradation product is an oxidized sugar.

13. The system of claim 1, wherein the sugar and the photonic antenna molecule are dissolved in water to form an aqueous solution and the catalyst is suspended in the aqueous solution.

14. The system of claim 1, wherein the photonic antenna molecule is distributed within a polymer.

15. The system of claim 14, wherein the polymer is polycarbonate or polyethylene.

16. (canceled)

17. A device for photocatalytically degrading a sugar, the device comprising a reaction chamber, wherein the reaction chamber comprises a photocatalytic degrading system comprising:
at least one photonic antenna molecule; and
at least one catalyst;
wherein the photonic antenna molecule is capable of collecting a light energy and transferring the light energy to the catalyst; and
wherein the catalyst is capable of converting the sugar into a degradation product.

18. The device of claim 17, wherein the reaction chamber further comprises a translucent surface.

19. The device of claim 18, wherein the photocatalytic degrading system is coated on or attached to the translucent surface.

20. The device of claim 17, wherein the photocatalytic degrading system is present in an aqueous solution.

21-26. (canceled)

27. A method for photocatalytically degrading a sugar comprising illuminating a light on a photocatalytic degrading system that is in contact with the sugar, wherein the photocatalytic degrading system comprises:
at least one photonic antenna molecule; and
at least one catalyst;
wherein the photonic antenna molecule collects the energy of the light and transfers the energy to the catalyst; and
the catalyst degrades the sugar to produce at least one degradation product with the energy of the light.

28. (canceled)
